(19) United States
(12) Patent Application Publication
(10) Pub. No.: US 2025/0269282 A1
(43) Pub. Date: Aug. 28, 2025

(54) LOCATING VIRTUAL CHARACTER IN VIRTUAL SCENES

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen (CN)

(21) Appl. No.: 19/205,953

(22) Filed: May 12, 2025

Related U.S. Application Data
(63) Continuation of application No. PCT/CN2024/072098, filed on Jan. 12, 2024.

(30) Foreign Application Priority Data
Mar. 16, 2023 (CN) 202310287983.0

(51) Int. Cl. A63F 13/55; A63F 13/52; A63F 13/822

(52) U.S. Cl. CPC A63F 13/55; A63F 13/52; A63F 13/822

(57) ABSTRACT

In a method for displaying a location of a first virtual character, the first virtual character located in a first virtual scene is displayed. Based on a first operation on the first virtual character, a first interface element corresponding to the first virtual character is displayed. The first interface element is configured to indicate a location of the first virtual character. Based on a second operation on the first interface element and the location of the first virtual character changing from the first virtual scene to a second virtual scene, the second virtual scene in which the first virtual character is located is displayed, and the first virtual character in the second virtual scene is displayed. Apparatus and non-transitory computer-readable storage medium counterpart embodiments are also contemplated.

### RELATED APPLICATIONS

The present application is a continuation of International Application No. PCT/CN2024/072098, filed on Jan. 12, 2024, which claims priority to Chinese Patent Application No. 202310287983.0, filed on Mar. 16, 2023. The entire disclosures of the prior applications are hereby incorporated by reference.

### FIELD OF THE TECHNOLOGY

This application relates to the field of computer and Internet technologies, including a method for displaying a virtual character.

### BACKGROUND OF THE DISCLOSURE

With development of Internet technologies, virtual socializing gradually becomes a favorite social manner of people. When a user account is in an online state, the user account may control a virtual character to interact with a virtual character controlled by another user account in a virtual scene.

In related art, the another user account may determine whether the user account is in the online state or an offline state according to online or offline information displayed in the user account settings. In a case that the user account is in the online state, the another user account may enter the virtual scene to search for a virtual character controlled by the user account, to implement interaction between the anther user account and the user account.

However, in the foregoing related art, interaction efficiency between user accounts is low.

### SUMMARY

Aspects of this disclosure include a method, an apparatus, and a non-transitory computer-readable storage medium for displaying a virtual character. Examples of technical solutions of this disclosure may be implemented as follows:

An aspect of this disclosure provides a method for displaying a location of a first virtual character. The first virtual character located in a first virtual scene is displayed. Based on a first operation on the first virtual character, a first interface element corresponding to the first virtual character is displayed. The first interface element is configured to indicate a location of the first virtual character. Based on a second operation on the first interface element and the location of the first virtual character changing from the first virtual scene to a second virtual scene, the second virtual scene in which the first virtual character is located is displayed, and the first virtual character in the second virtual scene is displayed.

An aspect of this disclosure provides an apparatus. The apparatus includes processing circuitry configured to display the first virtual character located in a first virtual scene. The processing circuitry is configured to display, based on a first operation on the first virtual character, a first interface element corresponding to the first virtual character. The first interface element is configured to indicate a location of the first virtual character. Based on a second operation on the first interface element and the location of the first virtual character changing from the first virtual scene to a second virtual scene, the processing circuitry is configured to display the second virtual scene in which the first virtual character is located, and the processing circuitry is configured to display the first virtual character in the second virtual scene.

An aspect of this disclosure provides a non-transitory computer-readable storage medium storing instructions which when executed by a processor cause the processor to perform any of the methods of this disclosure.

Technical solutions provided in the aspects of this disclosure include at least the following beneficial effects:

According to an operation on a first virtual character located in a first virtual scene, when the first virtual character is in the first virtual scene, a user may generate, through an operation, a first interface element corresponding to the character. After the character leaves the first virtual scene, the user may trigger the first interface element to quickly position a second virtual scene in which the first virtual character is currently located, so that a scene in which the first virtual character is currently located is quickly positioned by using the first interface element. In other words, different from the related art in which only whether a user account is in an online state or an offline state is learned, in this disclosure, a specific virtual scene in which a virtual character is located is learned by using the first interface element, and the virtual character and the virtual scene in which the virtual character is located are directly switched and displayed in response to a first operation on the first interface element, to implement one-click positioning for the first virtual character. Therefore, technical solutions provided in the aspects of this disclosure enrich interaction manners between user accounts, and improve interaction efficiency between the user accounts.

### BRIEF DESCRIPTION OF THE DRAWINGS

FIG. 1 is a schematic diagram of a solution implementation environment according to an aspect of this disclosure.

FIG. 2 is a schematic diagram of a method for displaying a virtual character according to an aspect of this disclosure.

FIG. 3 is a flowchart of a method for displaying a virtual character according to an aspect of this disclosure.

FIG. 4 is a flowchart of a method for displaying a virtual character according to another aspect of this disclosure.

FIG. 5 is a flowchart of a method for displaying a virtual character according to another aspect of this disclosure.

FIG. 6 is a flowchart of a method for displaying a virtual character according to another aspect of this disclosure.

FIG. 7 is a schematic diagram of a first control and a first interface element according to an aspect of this disclosure.

FIG. 8 is a schematic diagram of a first interface element according to an aspect of this disclosure.

FIG. 9 is a schematic diagram of a first interface element and a first virtual character according to an aspect of this disclosure.

FIG. 10 is a schematic diagram of an interface of permission setting according to an aspect of this disclosure.

FIG. 11 is a block diagram of a method for displaying a virtual character according to an aspect of this disclosure.

FIG. 12 is a block diagram of a method for displaying a virtual character according to another aspect of this disclosure.

FIG. 13 is a block diagram of an apparatus for displaying a virtual character according to an aspect of this disclosure.

FIG. 14 is a block diagram of an apparatus for displaying a virtual character according to another aspect of this disclosure.

FIG. 15 is a block diagram of a terminal device according to an aspect of this disclosure.

### DETAILED DESCRIPTION

To make objectives, technical solutions, and advantages of this disclosure clearer, examples of implementations of this disclosure are further described below in detail with reference to the accompanying drawings. Further, the descriptions of the terms are provided as examples only and are not intended to limit the scope of the disclosure.

According to this disclosure, a prompt interface or a pop-up window may be displayed, or voice prompt information may be outputted before collecting a user account and related data of a virtual character corresponding to the user account and during collecting user-related data. The prompt interface, the pop-up window, or the voice prompt information is configured for prompting a user that data related to the user is currently being collected, so that this disclosure only starts to perform related operations of obtaining the user-related data after obtaining a confirmation operation of the user for the prompt interface or the pop-up window, otherwise (that is, when the confirmation operation of the user for the prompt interface or the pop-up window is not obtained), ends the related operations of obtaining the user-related data, that is, skips obtaining the user-related data. In other words, the information (including, but is not limited to, user equipment information, user personal information, information about a virtual character controlled by a user account corresponding to a user, and the like), data (including, but is not limited to, data for analysis, stored data, displayed data, and the like), and signals involved in this disclosure are all authorized by the user or fully authorized by each party, and the collection, use, and processing of related data need to comply with relevant laws, regulations, and standards of relevant countries and regions. For example, user account information, information about a virtual character scene controlled by the user account, and location information involved in this disclosure is all obtained with full authorization.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 1 is a schematic diagram of a solution implementation environment according to an aspect of this disclosure. The solution implementation environment may include: a terminal device 10 and a server 20.

The terminal device 10 includes, but is not limited to, an electronic device such as a mobile phone, a tablet computer, a smart speech interaction device, a game console, a wearable device, a multimedia playback device, a personal computer (PC), an in-vehicle terminal, and a smart household appliance. A client of a target application (such as a game application) may be installed in the terminal device 10. In some aspects, the target application may be an application that needs to be downloaded and installed, or may be a click-to-use application. This is not limited in the aspects of this disclosure.

In the aspects of this disclosure, the target application may be any one of a social application, a simulation program, an escape shooting game, a virtual reality (VR) application, an augmented reality (AR) program, a three-dimensional map program, a VR game, an AR game, a first-person shooting (FPS) game, a multilayer gunfight survival game, a third-person shooting (TPS) game, a multilayer online battle arena (MOBA) game, a simulation game (SLG), or an interactive entertainment application. In addition, different applications support different types of social manners and virtual social scenes (which may also be referred to as virtual scenes). This is not limited in the aspects of this disclosure. In some aspects, the client of the foregoing application is run on the terminal device 10.

The foregoing virtual scene is a scene displayed (or provided) when the client of the target application (such as the social application) runs on the terminal device. The virtual scene may refer to a scene created for a virtual object to perform activities (such as game competition), such as a virtual house, a virtual island, or a virtual map. In some aspects, the virtual scene is a virtual environment. In some aspects, the virtual environment is an environment displayed (or provided) when an application runs on a terminal device. The virtual environment may be a simulated world of a real world, or may be a semi-simulated semi-fictional three-dimensional world, or may be an entirely fictional three-dimensional world. The virtual environment may be any one of a two-dimensional virtual environment, a 2.5-dimensional virtual environment, and a three-dimensional virtual environment. In some aspects, the virtual environment is further configured for a virtual environment battle between at least two virtual objects, and there are virtual resources available to the at least two virtual objects in the virtual environment.

The foregoing virtual object may refer to a virtual character, a virtual vehicle, a virtual item, or the like controlled by the user account in the target application. This is not limited in the aspects of this disclosure. For example, the target application is the social application. The virtual object may refer to a virtual character controlled by the user account in the social application. The virtual object may be in a human form, an animal form, a cartoon form, or another form. This is not limited in the aspects of this disclosure. The virtual object may be displayed in a three-dimensional form or a two-dimensional form. This is not limited in the aspects of this disclosure. In some aspects, when the virtual social scene is a 3D virtual environment, the virtual object is a 3D model created based on a skeletal animation technology. Each virtual object has a shape and size in the three-dimensional virtual environment, and occupies some space in the three-dimensional virtual environment. The activities of the virtual object include, but are not limited to: at least one of adjusting body postures, crawling, walking, running, riding, flying, jumping, driving, picking, shooting, attacking, or throwing. For example, the virtual object is a virtual person such as a simulated character role or a cartoon character role. In some implementations, the virtual object may be alternatively implemented by using a 2.5-dimensional model or a two-dimensional model. This is not limited in the aspects of this disclosure. For example, the virtual object may be divided into a user-controlled virtual object and a server-controlled virtual object according to different manners of controlling the virtual object. The user-controlled virtual object is an object that is movable in the virtual environment and that is controlled by a client. The server-controlled virtual object is a virtual object controlled by an automatic control algorithm or an artificial intelligence program on the client or the server. The server-controlled virtual object includes a movable object and an unmovable object in the virtual environment. For example, the virtual object in this disclosure is a virtual object controlled by the client.

The server 20 is configured to provide a backend service for the client of the target application in the terminal device 10. For example, the server 20 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

In the following aspect, only an example in which the virtual object is a virtual character is used for description. For examples of virtual objects other than the virtual character, reference can be made to the following aspect for the virtual character, and details are not described again. In some aspects, the terminal device 10 includes a first terminal device 11 (not shown in the figure) and a second terminal device 12 (not shown in the figure). The first terminal device is installed with a first client of the target application. The second terminal device is installed with a second client of the target application. A first user account of a first user controls a first virtual character in the first client of the target application. A second user account of a second user controls a second virtual character in the second client of the target application. In some aspects, the first virtual character and the second virtual character are located in the same virtual social scene or different virtual social scenes. In some aspects, the first virtual character and the second virtual character may have a friend relationship with each other, belong to the same camp, the same team, or the same organization, or have a temporary communication permission. In some aspects, the first virtual character and the second virtual character may not have a friend relationship, belong to different camps, different teams, or different organizations. In some aspects, the client installed on the first terminal device is the same as the client installed on the second terminal device, or the clients installed on the two terminal devices are the same type of clients of different operating system platforms (Android system or iOS system). The first terminal device may refer to one of a plurality of terminal devices, and the second terminal device may refer to another one of the plurality of terminal devices. In this aspect, the first terminal device and the second terminal device are merely used as an example for description.

The terminal device 10 and the server 20 may communicate with each other through a network. The network may be a wired network or a wireless network.

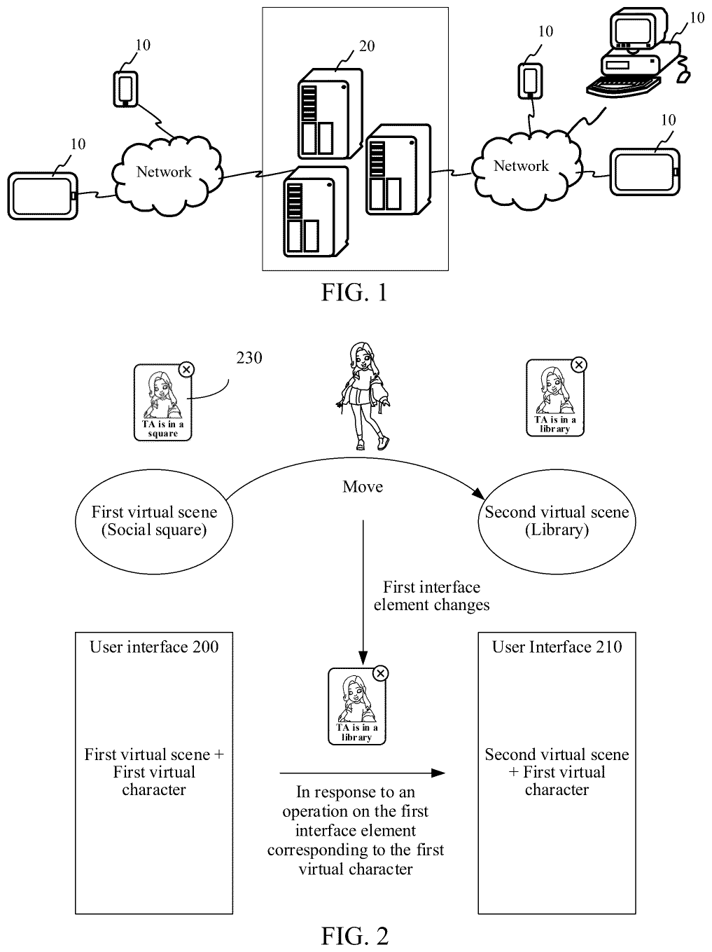

FIG. 2 is a schematic diagram of a method for displaying a virtual character according to an aspect of this disclosure.

During virtual socializing, a user performs social chatting by using a virtual character of the user and a virtual character of another person by customizing a two-dimensional or three-dimensional human-shaped model of the user. There are various social scenes in a virtual world, and a character may move to different social scenes to socialize, meeting different social requirements, for example, knowing a stranger in a stranger square, or studying in a library to implement self-discipline (knowing a stranger simultaneously). A location of the character is dynamic. When the user is interested in a character, the user has a requirement of intending to know a location at which the character is located. However, in the related art, if a user account does not enable a permission, another user account cannot learn a virtual scene in which the user account is located. In addition, even if the virtual scene in which the user account is located is learned, a virtual character controlled by the user account cannot be quickly positioned.

According to technical solutions provided in the aspects of this disclosure, the virtual character can be quickly positioned and a scene can be quickly switched. As shown in FIG. 2, when the first virtual character and the second virtual character are both in first virtual socializing, for example, a first virtual scene is a social square, virtual characters in the first virtual scene may not have a friend relationship with each other. In some aspects, the first virtual character and a scene in which the first virtual character is located are displayed on a user interface. In some aspects, if the second user account is interested in the first virtual character, and intends to learn which virtual scenes the first virtual character is going to subsequently, the second user account may perform an operation on the first virtual character, for example, long-press the first virtual character. In this case, a first control (which may also be referred to as a positioning control) appears beside the first virtual character, and then a first operation is performed on the first control, to display a first interface element (a positioner) 230. In this case, the virtual scene in which the first virtual character is located may be displayed on the positioner. For example, “TA is in a square” is displayed on the positioner. After leaving the first virtual scene, the first virtual character enters the second virtual scene. In some aspects, the second virtual scene is a library. Because the positioner constantly captures a scene and a location of the first virtual character, when the scene of the first virtual character changes, the scene displayed on the positioner also changes. For example, “TA is in a library” is displayed on the positioner. For example, the first virtual scene and the first virtual character are displayed on a user interface 200 of the terminal device. It is assumed that the first virtual character moves from the first virtual scene to a first location region of the second virtual scene, the terminal device displays the second virtual scene and the first virtual character on a user interface 210 in response to the first operation on the positioner. In some aspects, the user interface displays the first location region of the second virtual scene and the first virtual character located in the first location region.

When the first virtual character does not leave the first virtual scene, for example, the first virtual scene is the square, “TA is in a square” is always displayed on the positioner. After the first virtual character moves in the first virtual scene, and the first virtual character is not displayed on the user interface, because the positioner of the first virtual character has been displayed on the user interface of the first user account, a real-time location of the first virtual character can be perceived by the positioner in real time, the second user performs the first operation on the positioner, and the scene in which the first virtual character is located can be positioned. For example, it is assumed that the first virtual character moves from a second location region of the first virtual scene to a third location region of the first virtual scene, the terminal device displays, in response to the first operation on the positioner, the third location region of the first virtual scene and the first virtual character located in the third location region.

The positioner may always learn the scene and the location of the first virtual character. When the virtual scene and the location of the first virtual character change, the positioner also updates in real time. In this way, a requirement that the second user always intends to learn of the location of the virtual character controlled by the first user account is met, and the second user may further track the location of the first virtual character to interact with the first virtual character. As long as the second user intends to learn the location of the first virtual character, the second user can learn the location of the first virtual character and switch to the location of the first virtual character.

According to technical solutions provided in this aspect of this disclosure, in a case that the user account enables a permission, the first interface element (the positioner) is introduced, so that it is convenient for another user account to quickly position, by using the positioner, a scene and a location in which a virtual character controlled by the user account is located, thereby implementing one-click positioning and one-click scene switching. A virtual character controlled by the another user account may further be controlled to quickly go to a location of the virtual character controlled by the user account. Therefore, interaction efficiency of virtual socializing is improved, and interaction manners are further enriched.

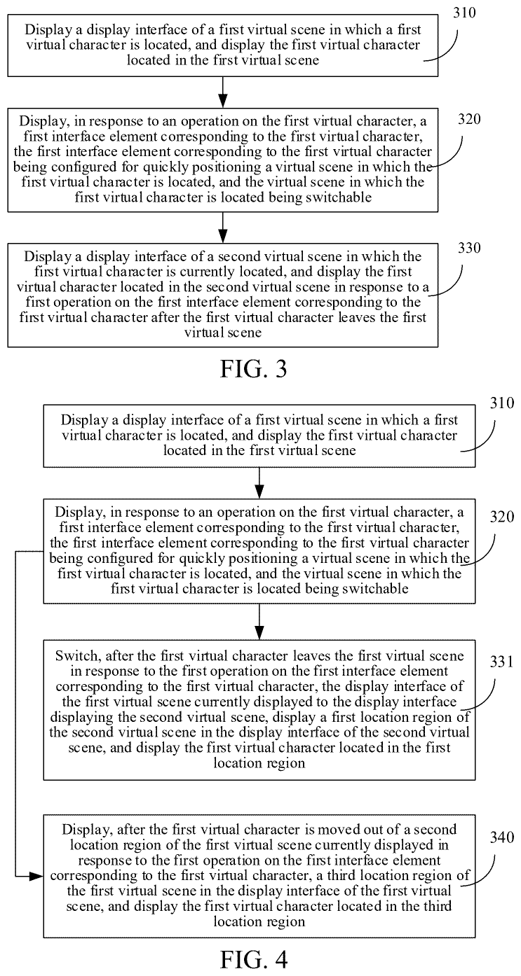

FIG. 3 is a flowchart of a method for displaying a virtual character according to an aspect of this disclosure. An execution body of each operation of the method may be the terminal device 10 in the solution implementation environment shown in FIG. 1. For example, the execution body of each operation may be the second client of the target application. In the following method aspects, for ease of description, the description is provided by merely using a “client” as the execution body of each operation. The method may include at least one operation in the following operations (310 to 330):

Operation 310: Display a display interface of a first virtual scene in which a first virtual character is located, and display the first virtual character located in the first virtual scene. For example, the first virtual character located in a first virtual scene is displayed.

First virtual character: It is an object controlled by the first user account of the target application, and includes, but is not limited to, a virtual person, a virtual animal, an animation, a cartoon character, or the like. In some aspects, the first virtual character may be displayed in a virtual scene in which the first virtual character is actually located, or displayed in a virtual scene in which the first virtual character is not actually located. In some aspects, the first user account controls the first virtual character to be located in the first virtual scene or the second virtual scene. In some aspects, the first virtual scene is one of a plurality of virtual scenes selected by the first user account. In some aspects, the first virtual scene is a scene provided for all user accounts to socialize. Regardless of a friend relationship between user accounts, virtual characters controlled by all user accounts may interact with each other in the first virtual scene. In some aspects, the first virtual scene is a virtual scene provided for strangers to socialize, and a friend relationship is not established between user accounts corresponding to virtual characters in the first virtual scene. For example, the first virtual scene is a social square. In some aspects, a virtual character controlled by the user can move in the first virtual socializing. In some other aspects, the first user account may control the first virtual character to leave from the first virtual scene and enter the second virtual scene. In some aspects, the second virtual scene is one of the plurality of virtual scenes selected by the first user account. For example, the second virtual scene is a library, the first location region is a desk in a fifth row and a fifth column of the library, and the first virtual character sits on the desk in the fifth row and the fifth column of the library. The library is considered as a virtual scene in which the first virtual character is actually located.

In some other aspects, a plurality of virtual characters in the target application are synchronously displayed in a comprehensive virtual scene without considering virtual scenes in which the virtual characters are actually located. In this case, the comprehensive virtual scene is considered to be a virtual scene in which a non-virtual character is actually located, but a scene in which only an image of the virtual character is displayed. In some aspects, when the user account logs in to the client of the target application, the user account is in the online state, and a virtual character controlled by the user account is automatically displayed in the comprehensive virtual scene. In some aspects, when the user account exits the client of the target application, the user account is in the offline state, and display of the virtual character controlled by the user account in the comprehensive virtual scene is cancelled. In some aspects, the first virtual character is displayed on a home page of the first user account. In this case, the virtual scene in which the first virtual character is located is not a virtual scene in which the first virtual character is actually located, and only a character image of the first virtual character is displayed on the home page of the first user account. In some aspects, the virtual character controlled by the user account or an artificial intelligence virtual character has corresponding identification information, which is configured for uniquely representing corresponding virtual characters. In some aspects, in the comprehensive virtual scene, the identification information is used to search whether the corresponding virtual character appears in the comprehensive virtual scene, to determine whether the virtual character is in the online state or the offline state. In this case, the artificial intelligence virtual character is considered as a virtual character controlled by the client or the server, and the client or the server controls the virtual character according to a set control logic. In some aspects, the artificial intelligence virtual character also correspondingly has online time and offline time. For example, in the target application, there are corresponding artificial intelligence robots (that is, artificial intelligence virtual characters). These artificial intelligence robots may publish daily tasks. To give a simple example, the artificial intelligence robot is a virtual teacher, and the artificial intelligence robot may publish a daily homework. There is a publishing time period corresponding to publishing of the homework. In some aspects, the first user account may search for the identification information of the artificial intelligence virtual character in the comprehensive virtual scene, to determine whether the artificial intelligence virtual character is in the online state (in other words, it is understood as whether it is a time period for releasing a task). In some aspects, when it is found that the virtual character is in the online state, a virtual scene in which the artificial intelligence virtual character is actually located may be positioned, and the artificial intelligence virtual character is displayed. For example of details on how to position and how to display, reference can be made to explanations and descriptions for the first virtual character in the following aspect. Details are not described herein again. In some other aspects, there may be a plurality of comprehensive virtual scenes. For example, the plurality of comprehensive virtual scenes are divided into two comprehensive virtual scenes according to different systems. One comprehensive virtual scene is configured for displaying all online virtual characters whose terminal devices in which the client is located are Android systems, and the other comprehensive virtual scene is configured for displaying all online virtual characters whose terminal devices in which the client is located are iOS systems. In some other aspects, even if the virtual character is in the offline state, the virtual character is also displayed in the comprehensive virtual scene, but is displayed differently from another virtual character in the online state. For example, an online virtual character is displayed in color, and an offline virtual character is displayed in black and white. In some aspects, the first virtual scene is the comprehensive virtual scene.

In some aspects, the user interface always displays a display interface centered on the second virtual character (a master virtual character) controlled by the second user account. In some aspects, when both the second virtual character and the first virtual character are located in the first virtual scene and a distance between the second virtual character and the first virtual character is less than a threshold, the display interface of the first virtual scene is displayed on the user interface, and the first virtual character and the second virtual character that are located in the first virtual scene are displayed. In some other aspects, in response to a perspective movement operation, when both the second virtual character and the first virtual character are located in the first virtual scene and the distance between the second virtual character and the first virtual character is greater than the threshold, the display interface of the first virtual scene is displayed on the user interface, and the first virtual character located in the first virtual scene is displayed without displaying the second virtual character. In other words, the first virtual character located in the same scene and the location of the first virtual character can be displayed by sliding a screen.

The display interface of the first virtual scene: A picture that is obtained by projecting the first virtual scene and that is configured for displaying on the user interface is referred to as the display interface. In some aspects, if the first virtual scene includes the first virtual character, the display interface includes the first virtual character. In some aspects, the projection is at least one of a parallel projection or a perspective projection.

Operation 320: Display, in response to an operation on the first virtual character, a first interface element corresponding to the first virtual character, the first interface element corresponding to the first virtual character being configured for quickly positioning a virtual scene in which the first virtual character is located, and the virtual scene in which the first virtual character is located being switchable. For example, based on a first operation on the first virtual character, a first interface element corresponding to the first virtual character is displayed. The first interface element is configured to indicate a location of the first virtual character.

First interface element: An element configured for quickly positioning a virtual scene in which the first virtual character is actually located. When the scene in which the first virtual character is located changes, the virtual scene in which the first virtual character is located that is quickly positioned by using the first interface element also changes. In some aspects, in response to an operation on the first interface element by the user, the virtual scene in which the first virtual character is located is switched for display. A specific expression type of the first interface element is not limited in the aspects of this disclosure. In some aspects, the first interface element is a floating window, a window, a control, or the like. A manner in which the first interface element displays the virtual scene in which the first virtual character is located is not limited in the aspects of this disclosure. In some aspects, the virtual scene corresponds to the identification information, and the identification information is configured for uniquely representing the virtual scene. In some aspects, the identification information of the virtual scene in which the first virtual character is located is displayed on the first interface element. In some aspects, the identification information includes, but is not limited to, information configured for identifying a virtual scene, such as a text identifier and a picture identifier. In some aspects, the first interface element is a small window. The first virtual character and a picture of the scene in which the first virtual character is located are synchronously displayed in the small window corresponding to the first interface element. In some aspects, the small window corresponding to the first interface element is located at an upper layer of a current user interface.

Virtual scene: It is a virtual environment set in the target application. In an example, reference can be made to the foregoing aspect. In some aspects, the virtual scene includes at least a virtual scene in which a virtual character is actually located and a virtual scene in which a virtual character is not actually located (the foregoing comprehensive virtual scene or referred to as the first virtual scene). In some aspects, the virtual scene in which the virtual character is actually located is considered to be a scene in which the virtual character can move. The virtual scene in which the virtual character is not actually located is considered to be a scene in which the virtual character is in the online state without considering a scene in which the virtual character is actually located. In other words, it is assumed that the first virtual character controlled by the user account is located in the second virtual scene. In this case, the first virtual character is synchronously displayed in a virtual environment (a comprehensive virtual scene or referred to as the first virtual scene) in which the first virtual character is not actually located. In some aspects, the first virtual character controlled by the first user account is located in a virtual scene of a library, and a character image of the first virtual character is also displayed in the comprehensive virtual scene, to prompt that the first virtual character is in the online state.

In addition, a virtual character controlled by the user may leave from the first virtual scene and move to the second virtual scene. Alternatively, a virtual character controlled by the user actually moves in the second virtual scene, but a character image of the virtual character is always displayed in the first virtual scene. This is not limited in this disclosure.

In some aspects, in response to the operation on the first virtual character, the first interface element of the first virtual character is displayed. In this disclosure, display timing for a first interface element of a specific first character may be in response to an operation on the first virtual character, or may be another trigger timing. A location of a region in which the first interface element is displayed on the user interface is not limited in this disclosure. In some aspects, the operation on the first virtual character is an operation configured for displaying the first interface element corresponding to the first virtual character. The operation on the first virtual character includes, but is not limited to, an operation such as clicking or sliding. A specific operation type of the operation on the first virtual character is not limited in this disclosure.

In some aspects, the first virtual character is located in the first virtual scene. In this case, the first interface element of the first virtual character is displayed on the user interface in response to the operation on the first virtual character. Specifically, at least one virtual character exists in the first virtual scene, and these virtual characters do not have a friend relationship with each other. In some aspects, when the first user account enables a first permission, in some aspects, the first permission is “allowing everyone to position his/her own location information”. The second user account may control the second virtual character to walk to the first virtual character. In this case, the user interface also displays the second virtual character. In response to the operation on the first virtual character, the first interface element of the first virtual character is displayed on the user interface, for the second user account to view and position the location of the first virtual character. In this case, all user accounts can display, by using the operation on the first virtual character, the first interface element of the first virtual character on the user interface corresponding to the user account. In other words, all user accounts can view the first interface element of the first virtual character, and quickly position the location of the first virtual character according to the first interface element. In some aspects, the first permission is “allowing a friend to position his/her own location information”. In response to the operation on the first virtual character, the first interface element of the first virtual character is displayed, for all user accounts that are in a friend relationship with the first user account to view and position the location of the first virtual character. In other words, a friend user account of the first user account can view the first interface element of the first virtual character, and quickly position the location of the first virtual character according to the first interface element.

In some other aspects, in addition to displaying the first interface element of the first virtual character in response to the operation on the first virtual character when the first virtual character is in the first virtual scene, the first interface element of the first virtual character may alternatively be displayed in response to the operation on the first virtual character when the first virtual character is located in another virtual scene. In some aspects, the second virtual character controlled by the second user account is located in the second virtual scene. It is assumed that, in this case, the first virtual character is located in the first virtual scene, for the second virtual character, the first virtual character may be displayed beside the second virtual character in response to a user search operation. In this case, it does not represent that the first virtual character is located beside the second virtual character, and only the character image of the first virtual character is displayed. In some aspects, after the character image of the first virtual character is displayed, the first interface element of the first virtual character is displayed. In some aspects, if both the first virtual character and the second virtual character are located in the second virtual scene, and the distance between the first virtual character and the second virtual character is less than the threshold, the first interface element of the first virtual character is displayed in response to the operation on the first virtual character.

In some other aspects, the first interface element of the first virtual character is displayed without considering content currently displayed on the user interface. In some aspects, regardless of which interface of the client is displayed on the current interface, the character image of the first virtual character is displayed in response to the search operation on identification information of the first virtual character, and the first interface element of the first virtual character is synchronously displayed.

In this aspect of this disclosure, display timing and a display location of the first interface element of the first virtual character are not limited. In addition to the manners mentioned in the foregoing aspects, another possible manner may be used.

Operation 330: Display, after the first virtual character leaves the first virtual scene, in response to a first operation on the first interface element corresponding to the first virtual character, a display interface of a second virtual scene in which the first virtual character is currently located, and display the first virtual character located in the second virtual scene. For example, based on a second operation on the first interface element and the location of the first virtual character changing from the first virtual scene to a second virtual scene, the second virtual scene in which the first virtual character is located is displayed, and the first virtual character in the second virtual scene is displayed.

First operation: It is configured for positioning an operation of the first virtual character. The first operation includes, but is not limited to, an operation such as clicking, double-clicking, or sliding. A specific operation type of the first operation is not limited in the aspects of this disclosure. Any operation on the first interface element and for positioning the virtual character may fall within the protection scope of this disclosure.

The second virtual scene is another virtual scene different from the first virtual scene. A specific scene type of the first virtual scene is not limited in this disclosure.

A display interface of a second virtual scene: A picture that is obtained by projecting the second virtual scene and that is configured for displaying on the user interface is referred to as the display interface. In some aspects, if the second virtual scene includes the first virtual character, the display interface includes the first virtual character. In some aspects, the projection is at least one of a parallel projection or a perspective projection.

In some aspects, if the first virtual character leaves the first virtual scene and enters the second virtual scene, in response to the first operation on the first interface element corresponding to the first virtual character, the second virtual scene in which the first virtual character is located is displayed and the first virtual character located in the second virtual scene is displayed. In some aspects, the second virtual scene of a threshold range is displayed by using the first virtual character as a center. In other words, the second virtual scene in which the first virtual character is located is positioned in the plurality of virtual scenes, and a region in which the first virtual character is located is positioned in the second virtual scene. After positioning, the region is synchronously displayed, so that the user can view a specific location of the first virtual character.

In some other aspects, a current user account is the second user account, and the second virtual character controlled by the second user account is located in a third virtual scene. In some aspects, in response to the first operation on the first interface element corresponding to the first virtual character, if the first virtual character is located in the second virtual scene, in addition to displaying the display interface of the second virtual scene in a first region of the user interface and displaying the first virtual character located in the second virtual scene, a display interface of the third virtual scene and the second virtual character located in the third virtual scene are further displayed in a second region of the user interface. In some aspects, region sizes of the first region and the second region may be adjusted. In other words, split-screen display is implemented, and when the first virtual character and the virtual scene in which the first virtual character is located are displayed, the second virtual character and the virtual scene in which the second virtual character is located are further displayed.

In technical solutions provided in the aspects of this disclosure, according to an operation on a first virtual character in a first virtual scene, when the first virtual character is in a first virtual scene, a user may generate, through an operation, a first interface element corresponding to the character. After the character leaves the first virtual scene, the user may trigger the first interface element to quickly position to a second virtual scene in which the first virtual character is currently located, so that a scene in which the first virtual character is currently located is quickly positioned by using the first interface element. In other words, different from the related art in which only whether a user account is in an online state or an offline state is learned, in this disclosure, a specific virtual scene in which a virtual character is located is learned by using the first interface element, and the virtual character and the virtual scene in which the virtual character is located are directly switched and displayed in response to a first operation on the first interface element, to implement one-click positioning for the first virtual character. Therefore, technical solutions provided in the aspects of this disclosure enrich interaction manners between user accounts, and improve interaction efficiency between the user accounts.

FIG. 4 is a flowchart of a method for displaying a virtual character according to another aspect of this disclosure. An execution body of each operation of the method may be the terminal device 10 in the solution implementation environment shown in FIG. 1. For example, the execution body of each operation may be the second client of the target application. In the following method aspects, for ease of description, the description is provided by merely using a “client” as the execution body of each operation. The method may include at least one operation in the following operations (310 to 340):

Operation 310: Display a display interface of a first virtual scene in which a first virtual character is located, and display the first virtual character located in the first virtual scene. For example, the first virtual character located in a first virtual scene is displayed.

Operation 320: Display, in response to an operation on the first virtual character, a first interface element corresponding to the first virtual character, the first interface element corresponding to the first virtual character being configured for quickly positioning a virtual scene in which the first virtual character is located, and the virtual scene in which the first virtual character is located being switchable. For example, based on a first operation on the first virtual character, a first interface element corresponding to the first virtual character is displayed. The first interface element is configured to indicate a location of the first virtual character.

Operation 331: Switch, after the first virtual character leaves the first virtual scene in response to the first operation on the first interface element corresponding to the first virtual character, the display interface of the first virtual scene currently displayed to the display interface displaying second virtual scene, display a first location region of the second virtual scene in the display interface of the second virtual scene and display the first virtual character located in the first location region. For example, based on the second operation on the first interface element, a switch from displaying the first virtual scene to displaying the second virtual scene is performed. A first location region in the second virtual scene and the first virtual character located in the first location region are displayed.

In some aspects, the first location region is a region in which the first virtual character is located in the second virtual scene. In some aspects, after the first virtual character leaves from the first virtual scene and enters the first location region of the second virtual scene, in response to the first operation on the first interface element corresponding to the first virtual character, the first location region of the second virtual scene is displayed in the display interface of the second virtual scene, and the first virtual character located in the first location region is displayed.

In some aspects, the current user interface displays the first virtual scene, and the second virtual character is located in the first virtual scene. In some aspects, the first virtual character leaves from the first virtual scene and is located in the first location region of the second virtual scene. In this case, in response to the first operation on the first interface element corresponding to the first virtual character, the display interface of the first virtual scene currently displayed is switched to the display interface displaying the second virtual scene, the display interface of the second virtual scene displaying the first location region of the second virtual scene and displaying the first virtual character located in the first location region.

In other words, no matter which type of virtual scene in which the first virtual character is located changes, the first virtual character can always be quickly positioned by using the first interface element corresponding to the first virtual character. If the virtual scene in which the first virtual character is located changes, a scene is first switched, and then a region in the scene is further switched. That is, a scene and a location of the virtual character are positioned, to implement precise positioning. The first virtual character may be precisely positioned in different virtual scenes by using the first interface element corresponding to the first virtual character, so that the first virtual character and the location region of the virtual scene in which the first virtual character is located may be displayed on the display interface in time when scene switching of the first virtual character occurs.

A manner of switching the display is not limited in the aspects of this disclosure. In some aspects, within threshold time and in a scene switching manner, the display interface of the first virtual scene currently displayed is switched to the display interface displaying the second virtual scene. In addition to being switched for display, the display interface of the first virtual scene and the display interface of the second virtual scene may be displayed on the same screen, to meet a requirement that the second user simultaneously views the second virtual character controlled by the second user account corresponding to the second user and the first virtual character controlled by the first user account corresponding to the first user.

Operation 340: Display, after the first virtual character is moved out of a second location region of the first virtual scene currently displayed in response to the first operation on the first interface element corresponding to the first virtual character, a third location region of the first virtual scene in the display interface of the first virtual scene, and display the first virtual character located in the third location region. For example, based on the second operation on the first interface element and the location of the first virtual character moving from a second location region of the first virtual scene, a third location region in the first virtual scene is displayed, and the first virtual character located in the third location region is displayed.

In some aspects, the first virtual character moves from the second location region to the third location region of the first virtual scene, and both the second location region and the third location region are regions in the first virtual scene. In some aspects, the second location region is also a location region in which the second virtual character is located. In some aspects, when the first virtual character is moved to the third location region of the first virtual scene, and the second virtual character is still located in the second location region of the first virtual scene, in response to the first operation on the first interface element corresponding to the first virtual character, the second location region of the first virtual scene currently displayed is switched to the third location region displaying the first virtual scene, and display the first virtual character located in the third location region.

A manner of switching the display is not limited in the aspects of this disclosure. In some aspects, the first virtual character is moved from the second location region to the third location region in a smooth moving manner within threshold time, to implement switching for display. In addition to being switched for display, the second location region of the first virtual scene and the third location region of the first virtual scene may be displayed on the same screen, to meet a requirement that the second user simultaneously views the second virtual character controlled by the second user account corresponding to the second user and the first virtual character controlled by the first user account corresponding to the first user.

In some aspects, in response to the first operation on the first interface element corresponding to the first virtual character, the second client sends an acquisition request for location information corresponding to the first virtual character to the server, and the server sends the location information corresponding to the first virtual character to the second client. In some aspects, the location information includes the first virtual scene in which the first virtual character is located and coordinate information of the first virtual character in the first virtual scene. In some aspects, after receiving the first virtual scene in which the first virtual character is located and the coordinate information of the first virtual character in the first virtual scene, the second client displays the display interface of the first virtual scene according to the first virtual scene in which the first virtual character is located and the coordinate information of the first virtual character in the first virtual scene, displays the third location region of the first virtual scene in the display interface of the first virtual scene, and displays the first virtual character located in the third location region.

In some aspects, when the first virtual character located in the third location region of the first virtual scene is displayed or the first virtual character located in the first location region of the second virtual scene is displayed, the first virtual character is differently displayed from another virtual character around the first virtual character. In some aspects, a method for differently displaying includes, but is not limited to, highlighting the display of the first virtual character, stroking the first virtual character, adding indication information to a location of the first virtual character, and the like.

In technical solutions provided in the aspects of this disclosure, for the second virtual character, in a case that the second virtual character is located in the same virtual scene and in different virtual scenes, the virtual scene in which the first virtual character is located can be displayed. Therefore, for the display of the first virtual character, a difference between virtual scenes may be ignored. Because the location region in which the first virtual character is located may be directly switched to display in response to the first operation on the first interface element, it is beneficial to quickly displaying the first virtual character, to meet a requirement that the first user intends to display the first virtual character controlled by himself/herself. In addition, because the display is directly switched, and a moving operation does not need to be complexly controlled, processing overheads required by a device for displaying the first virtual character are reduced.

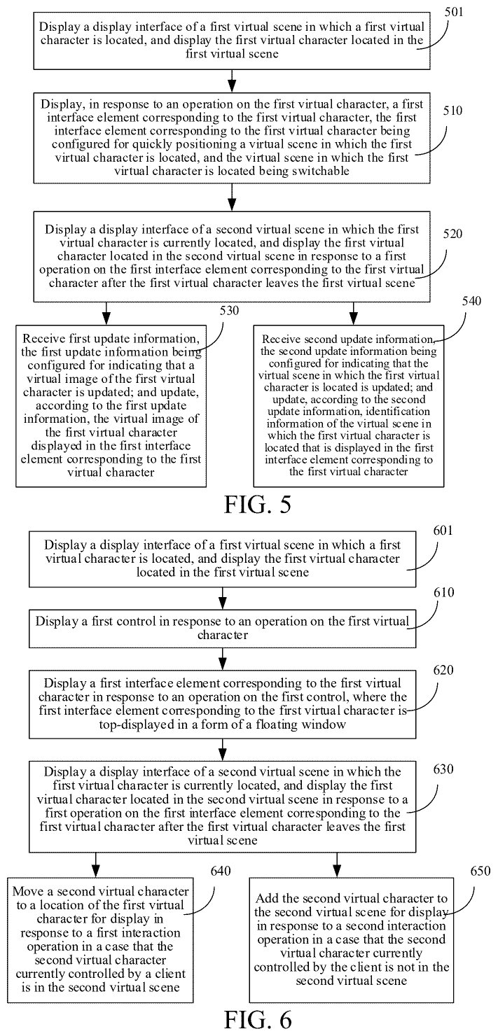

FIG. 5 is a flowchart of a method for displaying a virtual character according to another aspect of this disclosure. An execution body of each operation of the method may be the terminal device 10 in the implementation environment shown in FIG. 1. For example, the execution body of each operation may be the client of the target application. In the following method aspects, for ease of description, the description is provided by merely using a “client” as the execution body of each operation. The method may include at least one operation in the following operations (501 to 540):

Operation 501: Display a display interface of a first virtual scene in which a first virtual character is located, and display the first virtual character located in the first virtual scene. For example, the first virtual character located in a first virtual scene is displayed.

Operation 510: Display, in response to an operation on the first virtual character, a first interface element corresponding to the first virtual character, the first interface element corresponding to the first virtual character being configured for quickly positioning a virtual scene in which the first virtual character is located, and the virtual scene in which the first virtual character is located being switchable. For example, based on a first operation on the first virtual character, a first interface element corresponding to the first virtual character is displayed. The first interface element is configured to indicate a location of the first virtual character.

In some aspects, the first interface element corresponding to the first virtual character displays at least one of identification information of the first virtual character and identification information of the virtual scene in which the first virtual character is located.

In some aspects, the identification information of the first virtual character is any information that can uniquely represent the first virtual character. In some aspects, the identification information of the first virtual character includes, but is not limited to, a virtual image of the first virtual character and a name of the first virtual character. In some aspects, the name of the first virtual character is used as the identification information of the virtual character. In some aspects, the virtual image of the first virtual character is used as the identification information of the virtual character. In some aspects, the name and the virtual image of the first virtual character are used as the identification information of the virtual character. In some aspects, the name of the first virtual character is information that is set by the first user account or generated by the client itself and that uniquely represents the first virtual character.

In some aspects, the identification information of the virtual scene in which the first virtual character is located is any information that can uniquely represent the virtual scene. In some aspects, the identification information of the virtual scene in which the first virtual character is located includes, but is not limited to, a name of the virtual scene or an icon of the virtual scene. In some aspects, the name of the virtual scene in which the first virtual character is located is used as the identification information of the virtual scene. In some aspects, the icon of the virtual scene in which the first virtual character is located is used as the identification information of the virtual scene. In some aspects, the name and the icon of the virtual scene in which the first virtual character is located are used as the identification information of the virtual scene. In some aspects, the identification information of the virtual scene is information that is set by the user account or that is set by the target application and that uniquely represents the virtual scene.

In some aspects, the identification information of the first virtual character is displayed in the first interface element corresponding to the first virtual character. In some aspects, the identification information of the virtual scene in which the first virtual character is located is displayed in the first interface element corresponding to the first virtual character. In some aspects, the identification information of the first virtual character and the identification information of the virtual scene in which the first virtual character is located are displayed in the first interface element corresponding to the first virtual character.

In some aspects, if the name of the first virtual character is “Tao y”, the virtual image of the first virtual character is a little girl in black clothes, and the name of the virtual scene in which the first virtual character is located is a library, “Tao y, a virtual image of a little girl in black clothes, and a library” are displayed on the first interface element of the first virtual character. Identification information of the first virtual character (that is, the Tao y and the virtual image of the little girl in black clothes) and identification information of the virtual scene in which the first virtual character is located (that is, the library) are displayed in the first interface element corresponding to the first virtual character.

A specific form of the virtual image of the first virtual character is not limited in the aspects of this disclosure. In some aspects, the first user account can modify the virtual image of the first virtual character.

Operation 520: Display, after the first virtual character leaves the first virtual scene, in response to a first operation on the first interface element corresponding to the first virtual character, a display interface of a second virtual scene in which the first virtual character is currently located, and display the first virtual character located in the second virtual scene. For example, based on a second operation on the first interface element and the location of the first virtual character changing from the first virtual scene to a second virtual scene, the second virtual scene in which the first virtual character is located is displayed, and the first virtual character in the second virtual scene is displayed.

In some aspects, after operation 520, at least one of operation 521 to operation 524 (not shown in the figure) is further included.

Operation 521: Display at least one of a first option, a second option, and a third option in response to a second operation on the first interface element corresponding to the first virtual character. The first option is configured for entering a virtual scene in which the first virtual character is currently located, the second option is configured for inviting the first virtual character to enter a virtual scene in which the second virtual character currently controlled by the client is located, and the third option is configured for triggering the first virtual character and the second virtual character currently controlled by the client to jointly enter a third virtual scene.

In some aspects, the first operation is an operation on the first interface element that is configured for displaying at least one of the first option, the second option, and the third option. In some aspects, the first operation includes, but is not limited to, an operation such as clicking, double-clicking, or sliding. A specific operation type of the first operation is not limited in the aspects of this disclosure.

In some aspects, at least one of the first option, the second option, and the third option is displayed. In some aspects, any one of the first option, the second option, and the third option is displayed. In some aspects, any two of the first option, the second option, and the third option are displayed. In some aspects, the first option, the second option, and the third option are displayed. A number of options displayed in response to the second operation on the first interface element corresponding to the first virtual character is not limited in the aspects of this disclosure.

In some aspects, the first option, the second option, and the third option respectively correspond to different functions. For example details, reference can be made to the explanations and descriptions of the following operations. In some aspects, the first option, the second option, and the third option are displayed in a form of controls.

Operation 522: Display, in response to an operation on the first option, the display interface of the second virtual scene in which the first virtual character is currently located, and display the first virtual character located in the second virtual scene.

In some aspects, the operation on the first option is an operation configured for displaying the display interface of the second virtual scene in which the first virtual character is currently located and displaying the first virtual character located in the second virtual scene. In some aspects, the operation on the first option includes, but is not limited to, an operation such as clicking, double-clicking, or sliding. A specific operation type of the operation on the first option is not limited in the aspects of this disclosure.

Operation 523: Display a display interface of the virtual scene in which the second virtual character is located in response to an operation on the second option, and display the first virtual character switching from the scene in which the first virtual character is located to the virtual scene in which the second virtual character is located in a case that the first virtual character accepts an invitation.

In some aspects, the operation on the second option is an operation configured for displaying the display interface of the virtual scene in which the second virtual character is located, and displaying the first virtual character switching from the first virtual scene to the virtual scene in which the second virtual character is located in a case that the first virtual character accepts the invitation. In some aspects, the operation on the second option includes, but is not limited to, an operation such as clicking, double-clicking, or sliding. A specific operation type of the operation on the second option is not limited in the aspects of this disclosure.

In some aspects, the second client sends invitation information to the first client in response to the operation on the second option, the invitation information being configured for inviting the first virtual character to enter the virtual scene in which the second virtual character is located. In some aspects, after receiving the invitation information sent by the second client, the first client sends invitation feedback information to the second client in response to an invitation feedback operation of the first user account. In some aspects, the invitation feedback information includes an invitation agreement and an invitation rejection. The second client receives the invitation feedback information sent by the first client. In a case that the invitation feedback information is the invitation agreement, the virtual scene in which the second virtual character is located is displayed and the first virtual character switching from the first virtual scene to the virtual scene in which the second virtual character is located is displayed. That is, the first virtual character is invited to the virtual scene in which the second virtual character is located.

Operation 524: Display, in response to an operation on the third option, a display interface of the third virtual scene, and display the first virtual character and the second virtual character located in the third virtual scene.

In some aspects, the operation on the third option is an operation configured for displaying the display interface of the third virtual scene and displaying the first virtual character and the second virtual character located in the third virtual scene. In some aspects, the operation on the third option includes, but is not limited to, an operation such as clicking, double-clicking, or sliding. A specific operation type of the operation on the third option is not limited in the aspects of this disclosure.

In some aspects, the third virtual scene is one of virtual scenes of the target application. In some aspects, the third virtual scene may be another virtual scene that is different from the virtual scene in which the first virtual character is actually located and that is different from the virtual scene in which the second virtual character is actually located. In some aspects, the third virtual scene is selected by the second user, or determined by negotiation between the second user and the first user.

In some aspects, the third virtual scene is selected and determined by the second user. In some aspects, a name list of the virtual scene is displayed in response to the operation on the third option. In some aspects, in response to a scene selection operation on the third virtual scene in the name list of the virtual scene, the display interface of the third virtual scene is displayed. In some aspects, the scene selection operation is an operation configured for selecting the third virtual scene from the name list. Further, in addition to selecting the virtual scene, a third location in the third virtual scene may also be selected by the second user. In some aspects, in response to the scene selection operation on the third virtual scene in the name list of the virtual scene and a selection operation on the third location, identification information of the third virtual scene and location information of the third location in the third virtual scene are sent to the first client. In some aspects, after receiving the identification information of the third virtual scene and the location information of the third location in the third virtual scene that are sent by the second client, the first client controls the first virtual character to move to the third location in the third virtual scene.

In some aspects, the third virtual scene is determined by negotiation between the second user and the first user. In some aspects, after the second client sends the identification information of the third virtual scene and the location information of the third location in the third virtual scene to the first client, the second client receives negotiation information fed back by the first client. If the third virtual scene and the third location that are sent by the second client are recognized in the negotiation information, it represents that the negotiation succeeds. In this case, the first client controls the first virtual character to move to the third location in the third virtual scene, the second client controls the second virtual character to move to the third location in the third virtual scene, displays the display interface of the third virtual scene, and displays the first virtual character and the second virtual character located in the third virtual scene. In some aspects, if the third virtual scene and the third location that are sent by the second client are not recognized in the negotiation information, and the negotiation information fed back by the first client further includes a fourth virtual scene and a fourth location, after receiving the fourth virtual scene and the fourth location, the second client continues to negotiate until negotiation between the second client and the first client succeeds. The first user account and the second user account may alternatively negotiate in a form of a session box. A manner of determining the negotiation is not limited in this disclosure.

Operation 530: Receive first update information, the first update information being configured for indicating that a virtual image of the first virtual character is updated; and update, according to the first update information, the virtual image of the first virtual character displayed in the first interface element corresponding to the first virtual character. For example, update information indicating an update to one of a virtual image of the first virtual character and the identification information of the virtual scene in which the first virtual character is located is received. The one of the virtual image of the first virtual character displayed in the first interface element and the identification information of the virtual scene in which the first virtual character is located is updated based on the update information.

In some aspects, the first user account updates the virtual image of the first virtual character, to obtain a first update result. In some aspects, the first client sends the first update result to the server of the target application. In some aspects, after receiving the first update result, the server sends the first update information to the second client, and the first update information is configured for indicating that an image of the first virtual character is updated.

In some aspects, the first update result carries at least the identification information of the first virtual character and information about an updated virtual image of the first virtual character. In some aspects, the first update information carries at least the information about an updated virtual image of the first virtual character.

Operation 540: Receive second update information, the second update information being configured for indicating that the virtual scene in which the first virtual character is located is updated; and update, according to the second update information, identification information of the virtual scene in which the first virtual character is located that is displayed in the first interface element corresponding to the first virtual character.

In some aspects, the first user account updates the virtual scene in which the first virtual character is located, to obtain the second update result. In some aspects, the first client sends the second update result to the server of the target application. In some aspects, after receiving the second update result, the server sends the second update information to the second client, and the second update information is configured for indicating that the virtual scene in which the first virtual character is located is updated.

In some aspects, the second update result carries at least the identification information of the first virtual character and identification information of a virtual scene in which an updated first virtual character is located. In some aspects, the second update information carries at least the identification information of a virtual scene in which an updated first virtual character is located.

According to technical solutions provided in the aspects of this disclosure, according to an aspect, a virtual image of a first virtual character and identification information of a virtual scene in which the first virtual character is located are displayed on a first interface element of the first virtual character, so that the first virtual character and the virtual scene in which the first virtual character is correspondingly located can be determined, thereby avoiding a positioning error, and improving positioning accuracy.

According to another aspect, when the first user account changes the virtual image of the first virtual character and the virtual scene in which the first virtual character is located, the second client receives update information, and synchronously updates the virtual image of the first virtual character and the virtual scene in which the first virtual character is located that are displayed on a second client, reflecting real-time performance and accuracy of virtual socializing.

According to still another aspect, in the aspects of this disclosure, in response to a second operation on the first interface element, three options having different functions are displayed, and different functions are implemented for different options. Not only a virtual character controlled by another user account is switched to display by using one click, but also a virtual character controlled by the another user account is invited to a location of a virtual character controlled by a current user account by using one click, but also the virtual character controlled by the current user account and the virtual character controlled by the another user account are moved to places in which both the virtual character intends to go. Therefore, technical solutions provided in the aspects of this disclosure can meet different requirements of the user, enrich social manners of virtual socializing, and reflect social flexibility.

FIG. 6 is a flowchart of a method for displaying a virtual character according to another aspect of this disclosure. An execution body of each operation of the method may be the terminal device 10 in the implementation environment shown in FIG. 1. For example, the execution body of each operation may be the client of the target application. In the following method aspects, for ease of description, the description is provided by merely using a “client” as the execution body of each operation. The method may include at least one operation in the following operations (601 to 650):

Operation 601: Display a display interface of a first virtual scene in which a first virtual character is located, and display the first virtual character located in the first virtual scene. For example, the first virtual character located in a first virtual scene is displayed.

Operation 610: Display a first control in response to an operation on the first virtual character. For example, a first control element is displayed based on the first operation on the first virtual character.

In some aspects, the first virtual character is located in the first virtual scene, the first virtual scene is a virtual scene provided for strangers to socialize, and a friend relationship is not established between user accounts corresponding to virtual characters in the first virtual scene. In this case, any first virtual character displayed on a terminal device on which the second client is located may display the first control in response to the operation on the first virtual character.

The first virtual scene is set to a virtual scene provided for strangers to socialize, to provide conditions for social between a current user account and a stranger user account, thereby expanding a social intercourse circle of the current user account, and improving efficiency of virtual socializing.

In some aspects, a third control may be displayed for an operation on the third virtual character. In some aspects, the third virtual character is another virtual character different from the first virtual character and the second virtual character. In some aspects, in response to an operation on the third control, a first interface element corresponding to the third virtual character is displayed.

A location at which the virtual image corresponding to the first virtual character may appear is not limited in the aspects of this disclosure. In some aspects, an account home page of the first user account has a virtual image corresponding to the first virtual character. In some aspects, the virtual image of the first virtual character is displayed in the foregoing comprehensive virtual scene. In some aspects, the virtual image corresponding to the first virtual character may be obtained through searching by the second user account. In some aspects, the first control may be displayed in response to the operation on the first virtual character wherever the virtual image of the first virtual character appears. A location in which the virtual image of the first virtual character can be displayed in the target application and a manner of displaying the virtual image of the first virtual character are not limited in this disclosure.

In some aspects, the operation on the first virtual character is an operation configured for displaying the first control. In some aspects, the operation includes, but is not limited to, an operation such as clicking, double-clicking, or sliding. A specific operation type of a specific operation on the first virtual character is not limited in the aspects of this disclosure.

In some aspects, the first control is a user interface control. In some aspects, the user interface (UI) control is any visual control or element that can be seen on a user interface of an application, such as a picture, an input box, a text box, a button, and a label. Some UI controls, for example, a first control, response to a user operation. In some aspects, in response to an operation on the first control, the first interface element corresponding to the first virtual character is displayed. The UI control involved in the aspects of this disclosure includes, but is not limited to: the first control. A location of the first control on the interface is not limited in the aspects of this disclosure. In some aspects, in response to a click operation on the first virtual character, the first control is displayed on an upper right of the first virtual character.

In some aspects, after operation 610, operation 611 (not shown in the figure) is further included.

Operation 611: Display the first control in response to the operation on the first virtual character in a case that a first permission for the first virtual character is possessed. The first control is not displayed in a case that the first permission for the first virtual character is not possessed.

In some aspects, the first permission is a permission for allowing another user account to perform positioning. In some aspects, the first control is displayed in response to the operation on the first virtual character in a case that a permission that another user account is allowed to perform positioning is possessed. In some aspects, the first control is not displayed in response to the operation on the first virtual character in a case that a permission that another user account is allowed to perform positioning is not possessed.

In some aspects, the first permission may further be subdivided into a stranger permission and a friend permission. In some aspects, when the first permission is the stranger permission, the first permission is a permission for allowing any other user account, including a non-friend user account, to perform positioning. When the stranger permission is possessed, the first control is displayed in response to an operation performed by any user account for the first virtual character.

In some aspects, when the first permission is the friend permission, the first permission is a permission for allowing another friend user account to perform positioning. When the friend permission is possessed, the first control is displayed in response to an operation performed by any friend user account of the first user account for the first virtual character. Correspondingly, the first control is not displayed in response to an operation performed by any user account that is not a friend user account of the first user account for the first virtual character.

The friend user account is explained and described herein. The friend user account is a user account that has at least one of a friend relationship, a cooperation relationship, and a same camping relationship with the first user account.

The first permission is set for display of the first control, to prevent a user account that does not have the first permission from obtaining the location information of the first virtual character, thereby effectively ensuring privacy of the first virtual character, and improving security of virtual socializing.

Operation 620: Display a first interface element corresponding to the first virtual character in response to an operation on the first control. The first interface element corresponding to the first virtual character is top-displayed in a form of a floating window. For example, the first interface element is displayed based on a third operation on the first control element.

In some aspects, a plurality of first interface elements may be simultaneously displayed on the user interface, and different virtual characters correspond to different first interface elements, thereby quickly positioning different virtual characters according to a selection of a user.

The first virtual character is first operated, to display the first control, and then the first control is operated, to display the first interface element indicating that the first virtual character wins, so that a user account not having the first permission is prevented from obtaining the location information of the first virtual character, and another user account is prevented from mistakenly operating the first virtual character, thereby improving security of virtual socializing.

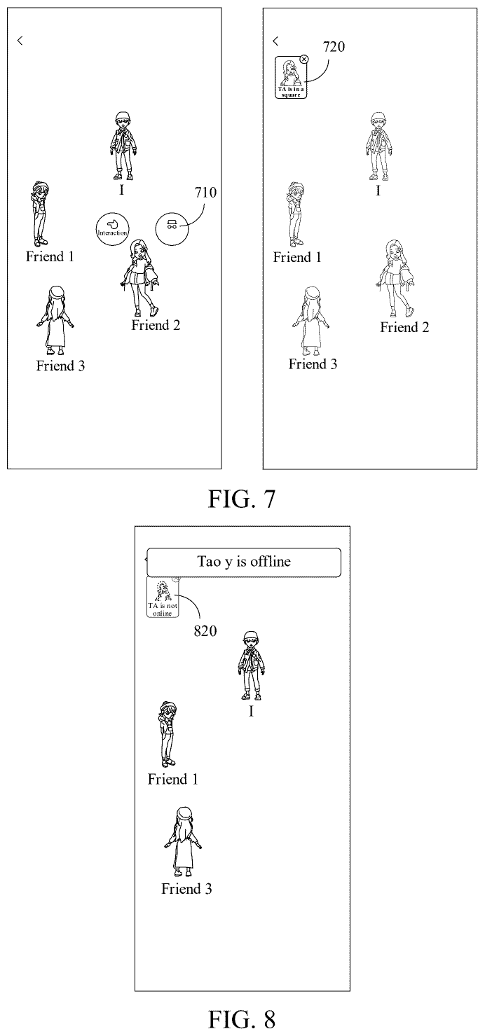

In some aspects, as shown in FIG. 7, in response to an operation on a first control 710, a first interface element 720 corresponding to a first virtual character is displayed.

In some aspects, the first interface element corresponding to the first virtual character is displayed in a first display style in a case that a user account corresponding to the first virtual character is in an online state.

In some aspects, the first interface element corresponding to the first virtual character is displayed in a second display style in a case that a user account corresponding to the first virtual character is in an offline state, where the first display style is different from the second display style.

In some aspects, as shown in FIG. 7, a first interface element 720 corresponding to the first virtual character is in the first display style. As shown in FIG. 8, a first interface element 820 corresponding to the first virtual character is in the second display style. In some aspects, in a case that the user account corresponding to the first virtual character is in the offline state, the first interface element is displayed in the second display style, and the first interface element displays that the first virtual character is offline. In some aspects, in response to a first operation on the first interface element of the first virtual character, offline prompt information “Tao y is already offline” is displayed, where Tao y is identification information of the first virtual character.

In some aspects, two display styles of the first interface element are designed for whether the user account is in the offline state or the online state. In some aspects, the first display style and the second display style correspond to first interface display elements of different colors. In some aspects, the second user may be helped quickly distinguish whether a current first user account is in the online state or in the offline state by using the two display styles, thereby improving efficiency of virtual socializing.

In some aspects, after operation 620, at least one of operation 621 to operation 622 (not shown in the figure) is further included.

Operation 621: Cancel, in response to a close operation on the first interface element corresponding to the first virtual character, display of the first interface element corresponding to the first virtual character.

In some aspects, the close operation is an operation configured for closing the first interface element. In some aspects, the operation includes, but is not limited to, an operation such as clicking, double-clicking, or sliding. An operation type of the close operation is not limited in the aspects of this disclosure.

Operation 622: Adjust, in response to a movement operation on the first interface element corresponding to the first virtual character, a display location of the first interface element corresponding to the first virtual character.

In some aspects, the movement operation is an operation configured for moving the first interface element. In some aspects, the operation includes, but is not limited to, an operation such as clicking, double-clicking, or sliding. An operation type of the movement operation is not limited in the aspects of this disclosure.

Closing or moving the first interface element implements flexible use of the first interface element, improves convenience of using the first interface element, and facilitates rapid social between another user account and the current user account.

Operation 630: Display, after the first virtual character leaves the first virtual scene, in response to a first operation on the first interface element corresponding to the first virtual character, a display interface of a second virtual scene in which the first virtual character is currently located, and display the first virtual character located in the second virtual scene. For example, based on a second operation on the first interface element and the location of the first virtual character changing from the first virtual scene to a second virtual scene, the second virtual scene in which the first virtual character is located is displayed, and the first virtual character in the second virtual scene is displayed.

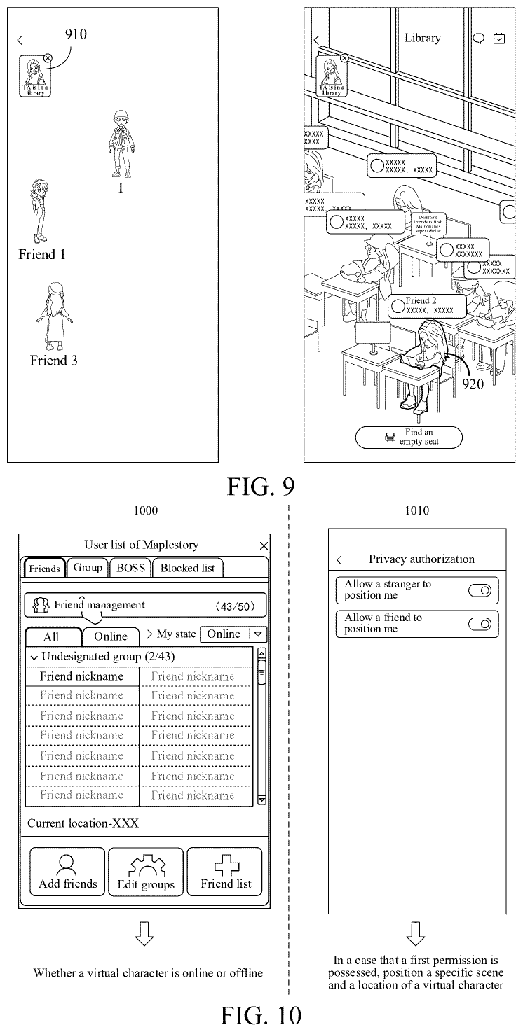

In some aspects, as shown in FIG. 9, in response to a first operation on a first interface element 910 corresponding to a first virtual character, if the first virtual character is located in a second virtual scene, a display interface of a second virtual scene library is displayed, and the first virtual character 920 located in the second virtual scene is displayed. In some aspects, the first virtual character is highlighted for display.

In some aspects, as shown in FIG. 10, FIG. 10 is a schematic diagram of a user interface of permission setting. In some aspects, as shown in 1000 of FIG. 10, a virtual social interface in the related art is displayed. In some aspects, the second user account and the first user account have a friend relationship. In some aspects, after the first user account exits a client of an application, the first user account is used as the second user account having a friend relationship, and may learn whether the first user account is in the online state or the offline state after logging in to the client. In a case that the first user account is in the online state, the virtual character controlled by the first user account is considered to be online. In a case that the first user account is in the offline state, the virtual character controlled by the first user account is considered to be offline. In the related art, due to a problem of permission setting of a user account, a user account that is not a friend of the first user account cannot view location information of the first virtual character controlled by the first user account. In some other aspects, the second user account as a friend user account of the first user account may view the virtual scene in which the first virtual character controlled by the first user account is located, but cannot position a specific location. If the second virtual character controlled by the second user account intends to go to a location of the first virtual character, the second virtual character cannot be directly reached, and the second virtual character needs to be controlled by the second user account to go to the location of the first virtual character. Therefore, the interaction efficiency is low. In addition, each time the second user account intends to query the location of the first virtual character, the second user account needs to open a list for querying. In this case, operations are complex.

An aspect of this disclosure provides a method for displaying a virtual character, to help a user learn of and quickly reach a location of a character followed, thereby resolving a problem of difficulty in finding a person in a virtual world. As shown in 1010 of FIG. 10, FIG. 10 is a diagram of an interface of permission setting according to an aspect of this disclosure. In a case that the first user account possesses the first permission, a specific virtual scene and a specific location of the virtual character may be positioned. In some aspects, if the first user account is set to possess the first permission, the first user account is in the online state, and the first virtual character controlled by the first user account is located in a first location region of the first virtual scene. The second user may position to the first virtual scene in which the first virtual character is located and position to the first location region in which the first virtual character is located. In some aspects, in 1010, if a permission “allow a stranger to position me” in the figure is enabled by the first user account of the user, the foregoing stranger permission (which may also be considered as the first permission) is enabled. In some aspects, in 1010, if a permission “allow a friend to position me” in the figure is enabled by the first user account of the user, the foregoing friend permission (which may also be considered as the first permission) is enabled. Therefore, according to technical solutions provided in the aspects of this disclosure, the virtual scene in which the second virtual character is located and the location can be quickly positioned, thereby improving interaction efficiency, and reducing processing overheads of a device to a certain extent.

Operation 640: Move the second virtual character to a location of the first virtual character for display in response to a first interaction operation in a case that a second virtual character currently controlled by a client is in the second virtual scene. For example, based on a first interaction operation, a second virtual character is moved to the location of the first virtual character in the second virtual scene.

In some aspects, the first interaction operation is an operation of moving the second virtual character to the location of the first virtual character in a case that the second virtual character currently controlled by a client is in the second virtual scene. In some aspects, the operation includes, but is not limited to, an operation such as clicking, double-clicking, or sliding. An operation type of the first interaction operation is not limited in the aspects of this disclosure.

In some aspects, there are at least three forms for moving the second virtual character to the location of the first virtual character. According to an aspect, the second client directly modifies coordinate information of the second virtual character, so that the second virtual character directly appears at the location of the first virtual character.

According to another aspect, the second client does not directly modify the coordinate information of the second virtual character, but controls the second virtual character to move to the location of the first virtual character. In some aspects, the client determines a shortest path according to location information of a current second virtual character and the location information of the second virtual character, and controls the second virtual character to quickly move to the location of the first virtual character at a speed upper limit value.

According to still another aspect, the second client determines the shortest path according to the location information of the current second virtual character and the location information of the second virtual character, and displays the shortest path between the first virtual character and the second virtual character. In this case, the second client can control the first virtual character to move only in response to a movement operation of the second virtual character controlled by the second user account.

Operation 650: Add the second virtual character to the second virtual scene for display in response to a second interaction operation in a case that a second virtual character currently controlled by the client is not in the second virtual scene.

In some aspects, the second interaction operation is an operation of moving the second virtual character to a location of the first virtual character in a case that the second virtual character currently controlled by the client is not in the second virtual scene. In some aspects, the operation includes, but is not limited to, an operation such as clicking, double-clicking, or sliding. An operation type of the second interaction operation is not limited in the aspects of this disclosure. In some aspects, the second virtual character is added to the location of the first virtual character in the second virtual scene for display in response to the second interaction operation.

In some aspects, the second client directly modifies the virtual scene information and the coordinate information of the second virtual character, so that the second virtual character is directly displayed at the location of the first virtual character in the first virtual scene.

In some other aspects, when the second virtual character is moved to the location of the first virtual character or is added to be displayed in the first virtual scene, the second client is controlled to automatically send arrival information to the first client, the arrival information being configured for prompting the first user account that the second virtual character is coming. In some aspects, the arrival information includes a virtual image of the second virtual character, user account information of the second virtual character, and the like. In some aspects, after receiving the arrival information, the first client may feed back reply information to the second client. In some aspects, the reply information is configured for indicating that the second virtual character controlled by the second user account corresponding to the second client may come to the side of the first virtual character or may not come to the first virtual character. In some aspects, when the reply information indicates that the second virtual character cannot come to the side of the first virtual character, the second virtual character cannot be moved to the side of the first virtual character. In some aspects, when the reply information indicates that the second virtual character may come to the side of the first virtual character but the distance between the second virtual character and the first virtual character exceeds the threshold, the second virtual character can only move beyond a threshold distance of the first virtual character.

In some aspects, after operation 650, operation 651 (not shown in the figure) is further included.

Operation 651: Display an interaction animation between the first virtual character and the second virtual character in the second virtual scene in response to an interaction operation on the first virtual character.

In some aspects, the interaction animation is a dynamic display picture of the interaction operation between the first virtual character and the second virtual character, and the interaction operation is an operation of intercourse between the first virtual character and the second virtual character. In some aspects, the operation includes, but is not limited to, an operation such as clicking, double-clicking, or sliding. An operation type of the interaction operation is not limited in the aspects of this disclosure. In some aspects, intercourse between the first virtual character and the second virtual character includes, but is not limited to, a dialogue intercourse, an action intercourse, and the like. In some aspects, the intercourse is the dialogue intercourse, and a dialog box between the first virtual character and the second virtual character is displayed in the second virtual scene. A dialogue input box is displayed on the second client, and the second user may input dialogue content. Correspondingly, the first client has a corresponding dialogue receiving box, and displays the dialogue content sent by the second user account. The interaction animation is a dynamic display picture of an interaction dialogue between the first user account and the second user account. In some other aspects, the intercourse is the action intercourse, and an action of the first virtual character and an action of the second virtual character are displayed in the second virtual scene. In some aspects, the second client displays at least one interaction operation control. In some aspects, in response to an operation on a target interaction operation control of the at least one interaction operation control, the second virtual character is controlled to perform an action directed by the target interaction operation control. In some aspects, types of the interaction operation directed by the interaction operation control include, but are not limited to, hugging, kissing, raising, clapping, and the like. The interaction animation is a dynamic display picture of the interaction action such as hugging, kissing, raising, and clapping. In some aspects, in response to the interaction operation control (for example, a type of the directed interaction operation is hugging), the second virtual character is controlled to hug the first virtual character. In some other aspects, a type of an interaction operation directed by the interaction operation control is related to a scene type of a virtual scene, and different interaction operation controls are displayed in different virtual scenes. For example, in a case that the virtual scene is a library, in this case, types of the interaction operation directed by the interaction operation control are a learning operation, a coaching operation, a question-answering operation, and the like. In a case that the virtual scene is a stadium, in this case, types of the interaction operation directed by the interaction operation control are a running operation, a rope skipping operation, and the like. In this case, a relationship between the virtual scene and the type of the interaction operation directed by the interaction operation control is preset by the application. An interaction operation that intends to be performed may alternatively be added by using the second user account, and a related interaction operation control is correspondingly displayed.

An interaction animation based on an interaction operation is displayed in a virtual scene, so that a display picture of an application may be enriched, enthusiasm of users for virtual socializing is improved, and interaction efficiency of the users is improved.

In technical solution provided in the aspects of this disclosure, in a case that the first permission is possessed, not only the first virtual character may be positioned and displayed, but also the second virtual character currently controlled by the client may be moved to display or may be added to display at the location of the first virtual character or in the virtual scene in which the first virtual character is located. While privacy is ensured, rapid social between virtual characters controlled by user accounts is implemented.

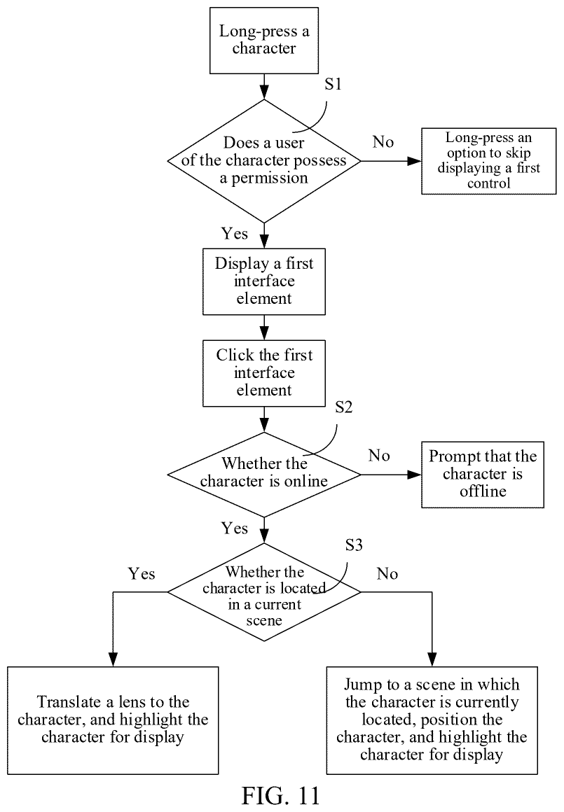

FIG. 11 is a block diagram of a method for displaying a virtual character according to an aspect of this disclosure. An execution body of each operation of the method may be the terminal device 10 in the implementation environment shown in FIG. 1. For example, the execution body of each operation may be the client of the target application. In the following method aspects, for ease of description, the description is provided by merely using a “client” as the execution body of each operation. The method may include at least one operation in the following operations (S1 to S3):

Operation S1: Determine whether a user possess a first permission.

A character to be positioned is long-pressed, and whether the character possesses a first permission is determined. If the character possesses the first permission, it indicates that the character can be positioned. If the character cannot be positioned, a first control is not displayed by long-pressing. If the character can be positioned, the first control is displayed.

The first control is clicked, and a first interface element is displayed on a screen. The first interface element changes in real time according to a location of the character. The first interface element is clicked.

Operation S2: Determine whether a character is still online.

If the character is offline, prompting that the character is offline. If the character is online, operation S3 is performed.

Operation S3: Determine whether the character is located in a current scene.

If the positioned character is located in a scene the same as a scene the user is currently located, a lens is translated to the character and the character is highlighted for display; or if the positioned character is located in a scene different from a scene in which the user is currently located, the scene in which the character is currently located is jumped to, the character is positioned and highlighted for display.

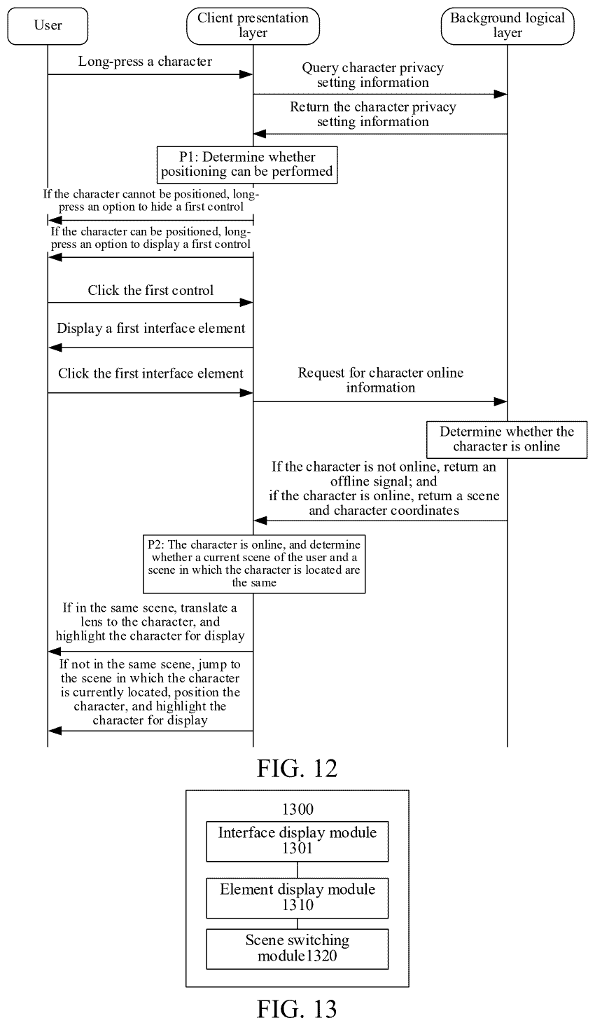

FIG. 12 is a block diagram of a method for displaying a virtual character according to another aspect of this disclosure. An execution body of each operation of the method may be the terminal device 10 in the implementation environment shown in FIG. 1. For example, the execution body of each operation may be the client of the target application. In the following method aspects, for ease of description, the description is provided by merely using a “client” as the execution body of each operation. The method may include at least one operation in the following operations (P1 to P2):

A user long-presses the character, and a client presentation layer (a second client) queries a background logical layer (a server) for character privacy setting information (whether a character possesses a first permission). In some aspects, the background logical layer returns the character privacy setting information.

Operation P1: A client presentation layer determines whether positioning can be performed.

If yes, the client presentation layer displays a first control. If not, the first control is hidden. When the first control is displayed, the user clicks the first control, and the client presentation layer displays the first interface element. The user clicks a first interface element, and the client presentation layer queries the background logical layer for online information of the character in response to a click operation of the user. The background logical layer determines whether the character is online. If the character is not online, the background logical layer returns an offline signal to the client presentation layer. If the character is online, the background logical layer returns a scene and character coordinates to the client.

Operation P2: The character is online, and the client presentation layer determines whether a current scene of a user (a second virtual character) and a scene in which a character (a first virtual character) is located are the same.

If the scene is the same, a lens is translated to the character, and the character is highlighted for display. If not in the same scene, the character is positioned, and the character is highlighted for display.

Technical solutions provided in the aspects of this disclosure provide intuitive display of a location of a character, so that a scene in which the character is located can be conveniently and quickly reached and a target character can be discovered, thereby meeting a following requirement of a user. The positioned character may conveniently gather with another friend in social of acquaintances, and meet sought-after appeal in social of strangers. Social efficiency is improved, and privacy is also considered.

The following is an apparatus aspect of this disclosure, which can be used to perform the method aspects of this disclosure. For example details not disclosed in the apparatus aspect of this disclosure, reference is made to the method aspects of this disclosure.

FIG. 13 is a block diagram of an apparatus for displaying a virtual character according to an aspect of this disclosure. The apparatus has a function of implementing the foregoing method example, and the function may be implemented by hardware or by hardware executing corresponding software. The apparatus may be the terminal device described above, or may be disposed in a terminal device. As shown in FIG. 13, the apparatus 1300 may include: an interface display module 1301, an element display module 1310, and a scene switching module 1320.

The interface display module 1301 is configured to display a display interface of a first virtual scene in which a first virtual character is located, and display the first virtual character located in the first virtual scene.

The element display module 1310 is configured to display, in response to an operation on the first virtual character, a first interface element corresponding to the first virtual character, the first interface element corresponding to the first virtual character being configured for quickly positioning a virtual scene in which the first virtual character is located, and the virtual scene in which the first virtual character is located being switchable.

The scene switching module 1320 is configured to: display, after the first virtual character leaves the first virtual scene, in response to a first operation on the first interface element corresponding to the first virtual character, a display interface of a second virtual scene in which the first virtual character is currently located, and display the first virtual character located in the second virtual scene.

In some aspects, the scene switching module 1320 is configured to: switch the display interface of the first virtual scene currently displayed to the display interface displaying the second virtual scene, display a first location region of the second virtual scene in the display interface of the second virtual scene, and display the first virtual character located in the first location region.

In some aspects, the scene switching module 1320 is further configured to: display, after the first virtual character is moved out of a second location region of the first virtual scene currently displayed, in response to the first operation on the first interface element corresponding to the first virtual character, a third location region of the first virtual scene in the display interface of the first virtual scene, and display the first virtual character located in the third location region.

In some aspects, the first interface element corresponding to the first virtual character displays: identification information of the first virtual character, and identification information of the virtual scene in which the first virtual character is located.

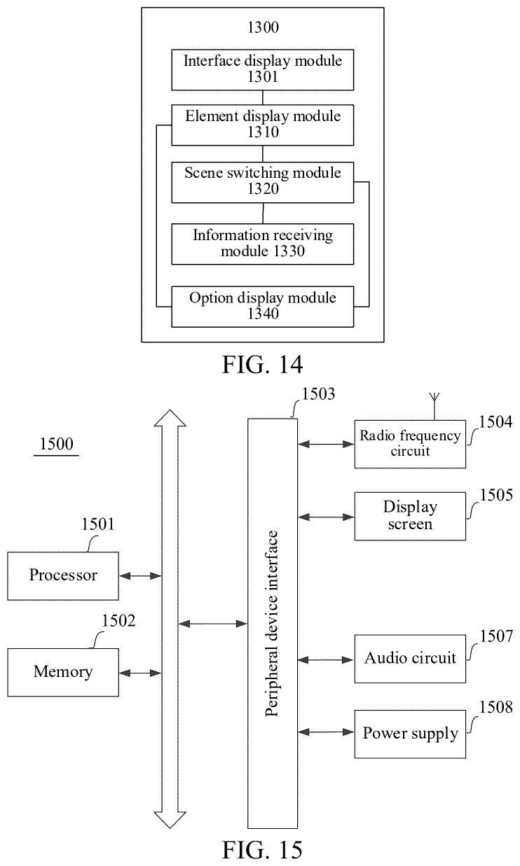

In some aspects, as shown in FIG. 14, the apparatus further includes an information receiving module 1330.

The information receiving module 1330, configured to: receive first update information, the first update information being configured for indicating that a virtual image of the first virtual character is updated; and update, according to the first update information, the virtual image of the first virtual character displayed in the first interface element corresponding to the first virtual character; or receive second update information, the second update information being configured for indicating that the virtual scene in which the first virtual character is located is updated; and update, according to the second update information, identification information of the virtual scene in which the first virtual character is located that is displayed in the first interface element corresponding to the first virtual character.

In some aspects, the element display module 1310 is configured to display a first control in response to an operation on the first virtual character.

The element display module 1310 is further configured to display a first interface element corresponding to the first virtual character in response to an operation on the first control, where the first interface element corresponding to the first virtual character is top-displayed in a form of a floating window.

In some aspects, the element display module 1310 is configured to display the first control in response to the operation on the first virtual character in a case that a first permission for the first virtual character is possessed, where the first control is not displayed in a case that the first permission for the first virtual character is not possessed.

In some aspects, the scene switching module 1320 is further configured to: move the second virtual character to a location of the first virtual character for display in response to a first interaction operation in a case that a second virtual character currently controlled by a client is in the second virtual scene; or add the second virtual character currently to the second virtual scene for display in response to a second interaction operation in a case that a second virtual character currently controlled by a client is not in the second virtual scene.

In some aspects, the scene switching module 1320 is further configured to display an interaction animation between the first virtual character and the second virtual character in the second virtual scene in response to an interaction operation on the first virtual character.

In some aspects, the element display module 1310 is further configured to: display the first interface element corresponding to the first virtual character in a first display style in a case that a user account corresponding to the first virtual character is in an online state; or display the first interface element corresponding to the first virtual character in a second display style in a case that a user account corresponding to the first virtual character is in an offline state, where the first display style is different from the second display style.

In some aspects, the element display module 1310 is further configured to: cancel, in response to a close operation on the first interface element corresponding to the first virtual character, display of the first interface element corresponding to the first virtual character; or adjust, in response to a movement operation on the first interface element corresponding to the first virtual character, a display location of the first interface element corresponding to the first virtual character.

In some aspects, as shown in FIG. 14, the apparatus further includes an option display module 1340.

The option display module 1340 is configured to display at least one of a first option, a second option, and a third option in response to a second operation on the first interface element corresponding to the first virtual character, where the first option is configured for entering a virtual scene in which the first virtual character is currently located, the second option is configured for inviting the first virtual character to enter a virtual scene in which the second virtual character currently controlled by the client is located, and the third option is configured for triggering the first virtual character and the second virtual character currently controlled by the client to jointly enter a third virtual scene.

The scene switching module 1320 is configured to display a display interface of a second virtual scene in which the first virtual character is currently located, and display the first virtual character located in the second virtual scene.

The scene switching module 1320 is further configured to: display a display interface of the virtual scene in which the second virtual character is located in response to an operation on the second option, and display the first virtual character switching from the virtual scene in which the first virtual character is located to the virtual scene in which the second virtual character is located in a case that the first virtual character accepts an invitation.

The scene switching module 1320 is further configured to: display, in response to an operation on the third option, a display interface of the third virtual scene, and display the first virtual character and the second virtual character that are located in the third virtual scene.

In some aspects, the first virtual scene is a virtual scene provided for strangers to socialize, and a friend relationship is not established between user accounts corresponding to virtual characters in the first virtual scene.

When the apparatus provided in the foregoing aspects implements functions of the apparatus, the division of the foregoing functional modules is merely an example for description. During actual application, the foregoing function allocation is completed by different functional modules according to needs, that is, the internal structure of the device is divided into different functional modules, to complete all or some of functions described above. In addition, the apparatus and method aspects provided in the foregoing aspects belong to the same conception. For the specific implementation process, reference may be made to the method aspects, and details are not described herein again.

FIG. 15 is a structural block diagram of a terminal device 1500 according to an aspect of this disclosure. The terminal device 1500 may be the terminal device 10 in the implementation environment shown in FIG. 1, and is configured to perform the method for displaying a virtual character provided in the foregoing aspects. Specifically,

The terminal device 1500 includes: processing circuitry, such as a processor 1501, and a memory 1502 (e.g., a non-transitory computer-readable storage medium).

The processor 1501 may include one or more processing cores, such as a 4-core processor or an 8-core processor. The processor 1501 may be implemented by using at least one hardware form of a digital signal processing (DSP), a field programmable gate array (FPGA), and a programmable logic array (PLA). The processor 1501 may also include a main processor and a coprocessor. The main processor is a processor configured to process data in an active state, also referred to as a central processing unit (CPU). The coprocessor is a low-power consumption processor configured to process data in a standby state. In some aspects, the processor 1501 may be integrated with a graphics processing unit (GPU). The GPU is configured to be responsible for rendering and drawing content that needs to be displayed in a display. In some aspects, the processor 1501 may alternatively include an artificial intelligence (AI) processor. The AI processor is configured to process a computing operation related to machine learning.

The memory 1502 may include one or more computer-readable storage media. The computer-readable storage media may be non-transitory. The memory 1502 may alternatively include a high-speed random access memory and a non-volatile memory, for example, one or more disk storage devices and flash storage devices. In some aspects, the non-transitory computer-readable storage medium in the memory 1502 is configured to store a computer program, the computer program being configured to be executed by one or more processors to implement the foregoing method for displaying a virtual character.

In some aspects, the terminal device 1500 may further include: a peripheral device interface 1503 and at least one peripheral device. The processor 1501, the memory 1502, and the peripheral device interface 1503 may be connected through a bus or a signal cable. Each peripheral device may be connected to the peripheral device interface 1503 through a bus, a signal cable, or a circuit board. Specifically, the peripheral device includes: at least one of a radio frequency circuit 1504, a display screen 1505, an audio circuit 1507, or a power supply 1508.

A person skilled in the art may understand that the structure shown in FIG. 15 constitutes no limitation to the terminal device 1500, and the terminal device may include more or fewer components than those shown in the figure, or some components may be combined, or a different component arrangement may be used.

In an aspect, a computer-readable storage medium such as a non-transitory computer-readable storage medium is further provided, having a computer program stored therein, and the computer program being executed by a processor to implement the foregoing method for displaying a virtual character.

In some aspects, the computer-readable storage medium may include: a read-only memory (ROM), a random access memory (RAM), a solid state drives (SSD), an optical disc, or the like. The RAM may include a resistance random access memory (ReRAM) and a dynamic random access memory (DRAM).

In an aspect, a computer program product is further provided, the computer program product including a computer program, the computer program being stored in a computer-readable storage medium. A processor of a terminal device reads the computer program from the computer-readable storage medium, and executes the computer program, to cause the terminal device to perform the foregoing method for displaying a virtual character.

“A plurality of” mentioned in this specification refers to two or more. “And/or” describes an association relationship between associated objects and represents that three relationships may exist. For example, A and/or B may represent the following three cases: Only A exists, both A and B exist, and only B exists. The character “/” generally represents an “or” relationship between the associated objects. In addition, the operation numbers described in this specification merely schematically show a possible execution sequence of the operations. In some other aspects, the operations may not be performed based on the number sequence. For example, two operations with different numbers may be performed simultaneously, or two operations with different numbers may be performed based on a sequence contrary to the sequence shown in the figure. This is not limited in the aspects of this disclosure.

The foregoing descriptions are merely examples of aspects of this disclosure, and are not intended to limit this disclosure. Any modification, equivalent replacement, or improvement made within the spirit and principle of this disclosure shall fall within the scope of this disclosure.

What is claimed is:

1. A method for displaying a location of a first virtual character, the method comprising:
displaying the first virtual character located in a first virtual scene;
displaying, based on a first operation on the first virtual character, a first interface element corresponding to the first virtual character, the first interface element being configured to indicate a location of the first virtual character; and
based on a second operation on the first interface element and the location of the first virtual character changing from the first virtual scene to a second virtual scene,
displaying the second virtual scene in which the first virtual character is located, and
displaying the first virtual character in the second virtual scene.

2. The method according to claim 1, wherein the displaying the second virtual scene comprises:
switching from displaying the first virtual scene to displaying the second virtual scene; and
displaying a first location region in the second virtual scene and the first virtual character located in the first location region.

3. The method according to claim 1, further comprising:
based on the second operation on the first interface element and the location of the first virtual character moving from a second location region of the first virtual scene, displaying a third location region in the first virtual scene, and displaying the first virtual character located in the third location region.

4. The method according to claim 1, wherein the first interface element displays at least one of:
identification information of the first virtual character or the first virtual scene in which the first virtual character is located.

5. The method according to claim 4, further comprising:
receiving update information indicating an update to one of a virtual image of the first virtual character and the identification information of the first virtual scene in which the first virtual character is located; and
updating the one of the virtual image of the first virtual character displayed in the first interface element and the identification information of the first virtual scene in which the first virtual character is located based on the update information.

6. The method according to claim 1, wherein the displaying the first interface element comprises:
displaying a first control element based on the first operation on the first virtual character; and
displaying the first interface element based on a third operation on the first control element.

7. The method according to claim 6, wherein the displaying the first control element comprises:
based on the first operation on the first virtual character, displaying the first control element when a first permission associated with the first virtual character allows locating by another user account, wherein
the first control element is not displayed when the first permission is not granted.

8. The method according to claim 1, further comprising:
based on a first interaction operation, moving a second virtual character to the location of the first virtual character in the second virtual scene.

9. The method according to claim 8, further comprising:
displaying an interaction animation between the first virtual character and the second virtual character in the second virtual scene based on a second interaction operation.

10. The method according to claim 1, wherein
the first interface element is displayed in a first display style when a user account associated with the first virtual character is in an online state;
the first interface element is displayed in a second display style when the user account associated with the first virtual character is in an offline state; and
the first display style is different from the second display style.

11. The method according to claim 1, further comprising:
based on a movement operation on the first interface element, adjusting a display location of the first interface element.

12. The method according to claim 1, further comprising:
displaying at least one selectable option in response to a third operation on the first interface element corresponding to the first virtual character, wherein the at least one selectable option includes at least one of:
a first option configured to control a second virtual character to enter the second virtual scene in which the first virtual character is located;
a second option configured to invite the first virtual character to enter a different virtual scene in which the second virtual character is located; and
a third option configured to initiate joint entry of the first virtual character and the second virtual character into a third virtual scene.

13. An apparatus, comprising:
processing circuitry configured to:
display a first virtual character located in a first virtual scene;
display, based on a first operation on the first virtual character, a first interface element corresponding to the first virtual character, the first interface element being configured to indicate a location of the first virtual character; and
based on a second operation on the first interface element and the location of the first virtual character changing from the first virtual scene to a second virtual scene,
display the second virtual scene in which the first virtual character is located, and
display the first virtual character in the second virtual scene.

14. The apparatus according to claim 13, wherein to display the second virtual scene the processing circuitry is configured to:
switch from displaying the first virtual scene to displaying the second virtual scene; and
display a first location region in the second virtual scene and the first virtual character located in the first location region.

15. The apparatus according to claim 13, wherein the processing circuitry is configured to:
based on the second operation on the first interface element and the location of the first virtual character moving from a second location region of the first virtual scene, display a third location region in the first virtual scene, and display the first virtual character located in the third location region.

16. The apparatus according to claim 13, wherein the first interface element displays at least one of:
identification information of the first virtual character or the first virtual scene in which the first virtual character is located.

17. The apparatus according to claim 16, wherein the processing circuitry is configured to:
receive update information indicating an update to one of a virtual image of the first virtual character and the identification information of the first virtual scene in which the first virtual character is located, and
update the one of the virtual image of the first virtual character displayed in the first interface element and the identification information of the first virtual scene in which the first virtual character is located based on the update information.

18. The apparatus according to claim 13, wherein the processing circuitry is configured to:
display a first control element based on the first operation on the first virtual character; and
display the first interface element based on a third operation on the first control element.

19. The apparatus according to claim 18, wherein the processing circuitry is configured to:
based on the first operation on the first virtual character, display the first control element when a first permission associated with the first virtual character allows locating by another user account, wherein
the first control element is not displayed when the first permission is not granted.

20. A non-transitory computer-readable storage medium storing instructions which, when executed by a processor, cause the processor to perform:
displaying a first virtual character located in a first virtual scene;
displaying, based on a first operation on the first virtual character, a first interface element corresponding to the first virtual character, the first interface element being configured to indicate a location of the first virtual character; and
based on a second operation on the first interface element and the location of the first virtual character changing from the first virtual scene to a second virtual scene,
displaying the second virtual scene in which the first virtual character is located, and
displaying the first virtual character in the second virtual scene.
